(19) United States
(12) Patent Application Publication
(10) Pub. No.: US 2007/0210557 A1
(43) Pub. Date: Sep. 13, 2007

(54) Trailer device

(76) Inventor: Rawlyn W. Richter, Uvalde, TX (US)

Correspondence Address: Rawlyn Richter, 2508 Ganer Field Road, Uvalde, TX, 78801, US

(21) Appl. No.: 11/248,972

(22) Filed: Oct. 11, 2005

(51) Int. Cl. B62D 13/00

(52) U.S. Cl. 280/443

(57) ABSTRACT

A trailer device for attachment to a hitch of a tow vehicle, the trailer device comprising a bed, or some other type of load carrying portion, connected for pivotal movement with respect to the axle/cargo connection. The bed is movable between a generally horizontal, hauling position and a swiveling position. The bed includes a forward portion adjacent the draw bar and a rearward portion opposite the forward portion. An axle is connected to the bed to which wheels and a swivel attachment pin are attached.

### CROSS-REFERENCE TO RELATED APPLICATION

### STATEMENT REGARDING FEDERALLY SPONSORED RESEARCH OR DEVELOPMENT

Not applicable

### REFERENCE TO SEQUENCE LISTING

Not applicable

### FIELD OF THE INVENTION

The present invention relates to trailer device having a bed or box which swivels, or rotates on its axel, for the purpose of loading or unloading.

### BACKGROUND OF THE INVENTION

Trailer devices which have a bed or body portion configured for carrying cargo and for tilting in order to offload, or dump the cargo. Dump trailer devices are useful in that they offer a cargo-emptying feature without requiring a dedicated vehicle, such as a dump truck. A dump trailer device can be used as needed by attaching it to a tow vehicle, such as a conventional truck, tractor, pick-up truck, sport utility vehicle (SUV), automobile, etc. Once the desired cargo has been loaded and unloaded using the trailer device, the trailer device could then be detached from the tow vehicle, and the tow vehicle is then unencumbered and free to be used for other purposes.

Various types of trailer device and dump trailer devices have been patented. U.S. Pat. No. 3,189,387, issued Nieto, Jr., discloses eccentric rim members which are mounted in front of trailer device wheels, and which rotate in a manner that lifts the trailer device into a dumping position as a trailer device is pulled forwardly. U.S. Pat. No. 6,238,166 B1, issued to Collier, discloses a utility trailer device with selectively deployable chains. Upon deployment of the chains and backing of the trailer device, the tires engage the chain, and the trailer device moves into a dumping position.

U.S. Pat. No. 5,544,944, issued to Keech; U.S. Pat. No. 4,711,499, issued to Fortin; U.S. Pat. No. 1,894,320, issued to Muchenberger-Wittlinger; and U.S. Pat. No. 4,511,181, issued to Schantz, all disclose tilting trailer devices that pivot at the end of a tow bar. In particular, the Keech patent discloses uses of a tilt lock mechanism, and the Fortin patent discloses a sliding hinge for dumping upon rearward movement. The Schantz patent allows for storage of a trailer device in a vertical position.

Another desirable feature in a dump trailer device is to provide a trailer device which does not have to be detached from the tow vehicle in order to perform the dumping or unloading operation. Additionally, if such unloading could take place without requiring a separate, powered mechanism, such would be a further advantage.

None of the current inventions and patents taken either singly or in combination as searched describe the instant invention as claimed. Accordingly, it is among the objects of the present invention to provide a novel trailer device which is simple to manufacturer, and economical in cost.

### SUMMARY OF THE INVENTION

It is, therefore, an object of the present invention to provide a trailer device which does not require an auxiliary power unit or other power mechanism in order to perform the swiveling function.

Another object of the present invention is to provide a trailer device which may remain attached to a tow vehicle during unloading operation.

A further object of the present invention is to provide a swiveling trailer device which may be swiveled manually for loading or unloading from either end of the trailer device.

A still further object of the present invention is to provide a trailer device which, after being moved to the loading or unloading position, may be returned to its normal, cargo-hauling position, by swinging the tow arm forward.

Yet another object of the present invention is to provide a trailer device which may be tilted in either direction during the swiveling or unloading operation.

A still further object of the present invention is to provide a method of operating a trailer device.

Yet another object of the present invention is to provide a swiveling trailer device, wherein the swiveling feature may be activated and deactivated by the user from the front-end of the trailer device.

Generally, the present invention includes a trailer device having a draw bar and coupler for attachment to a hitch of a tow vehicle, the trailer device comprising a bed connected to a frame for pivotal movement with respect to the axle. The bed or other load carrying structure is movable between a generally horizontal, hauling position and a swiveling position. The bed includes a forward portion adjacent the draw bar and a rearward portion opposite the forward portion. An axle is connected to the frame to which wheels and swivel point are attached.

More specifically, the present invention includes a method of swiveling a trailer device and a trailer device having a mechanism wherein the swivel ability is locked during tow and can be unlocked during loading or unloading.

Activation of the swivel is accomplished through use of a release mechanism, such as a pin arrangement, or through the use of a linkage preferably allowing the swivel to be released by the user, as mentioned above, while the user stands at the forward end of the trailer device.

It should be noted that as the bed tilts, its rear edge contacts the ground, and at this point, the bed itself becomes a ramp for allowing riding mowers, all terrain vehicles, go carts, tractors, etc. to be driven or otherwise loaded onto bed, if desired.

The trailer device of the present invention includes a draw bar having a unique configuration which allows the trailer device to be loaded or unloaded without requiring it to be unhitched from the tow vehicle. This is allowed by virtue of the swiveling member connecting the bed tongue to the axle.

Accordingly, the trailer device of the present invention requires no powered swiveling mechanism, auxiliary or otherwise. This eliminates the need for power supply mechanisms, which are generally power take-off (PTO) hydraulic mechanisms, drawing motive power from the tow vehicle, or electric-hydraulic mechanisms, which require use of an electrically-powered hydraulic pump.

Further, typical dump trailer devices, because of their need for separate power devices for performing the swiveling operation, must generally include increased structural support for supporting such dump mechanisms, which in turn adds weight and cost to the trailer device. This weight and cost is in addition to that of the powered swiveling system itself.

The trailer device of the present invention, by eliminating the need for a powered swiveling mechanism, can be made to be relatively lightweight and easy to move around by hand, thereby allowing enhanced maneuverability of the trailer device in tight areas.

Because the trailer device of the present invention requires no additional power source, such as an electrical hook-up or a hydraulic power take-off, to connect to the tow vehicle's PTO system, the trailer device can be used with almost any vehicle having an ordinary trailer device hitch.

Moreover, by virtue of the design of the trailer device of the present invention, the bed of the trailer device is preferably elevated, compared to other trailer devices, thereby allowing easy access at the rear and sides for loading or off-loading with conventional lift trucks, such as forklifts, making the trailer device attractive for use to business owners and, in particular, to the construction industry.

It is an objective of the invention to provide a trailer device which is relatively easier to use and more accurate than existing trailers.

It is another objective to provide trailer device which is unitary in construction and does not require additional support equipment or power.

It is a further object of the invention to provide trailer device which is designed to be light and easy to use.

It is yet a further object of the invention to provide trailer device which is inexpensive and easy to manufacture.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a trailer device and method which has many of the advantages of the current trailers and many novel features that result in a trailer device which is not anticipated, rendered obvious, suggested, or even implied by any of the prior art, either alone or in any combination thereof.

It is another object of the present invention to provide trailer device which may be easily and efficiently manufactured and marketed.

It is a further object of the present invention to provide trailer device which is of a reliable nature.

An even further object of the present invention is to provide trailer device which is susceptible of a low cost of manufacture with regard to both materials and labor, and which accordingly is then susceptible of low prices of sale to the consuming professionals, thereby making such software economically available to the buying public.

Still yet another object of the present invention is to provide a trailer device which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying descriptive matter in which there are illustrated preferred embodiments of the invention.

### ILLUSTRATIONS

FIG. 1

FIG. 1 is a left side perspective of the current device displaying the device with a trailer hitch connection 1, and trailer neck 2, swivel release 3 in a locked position, swivel lock 4 and trailer walls 5.

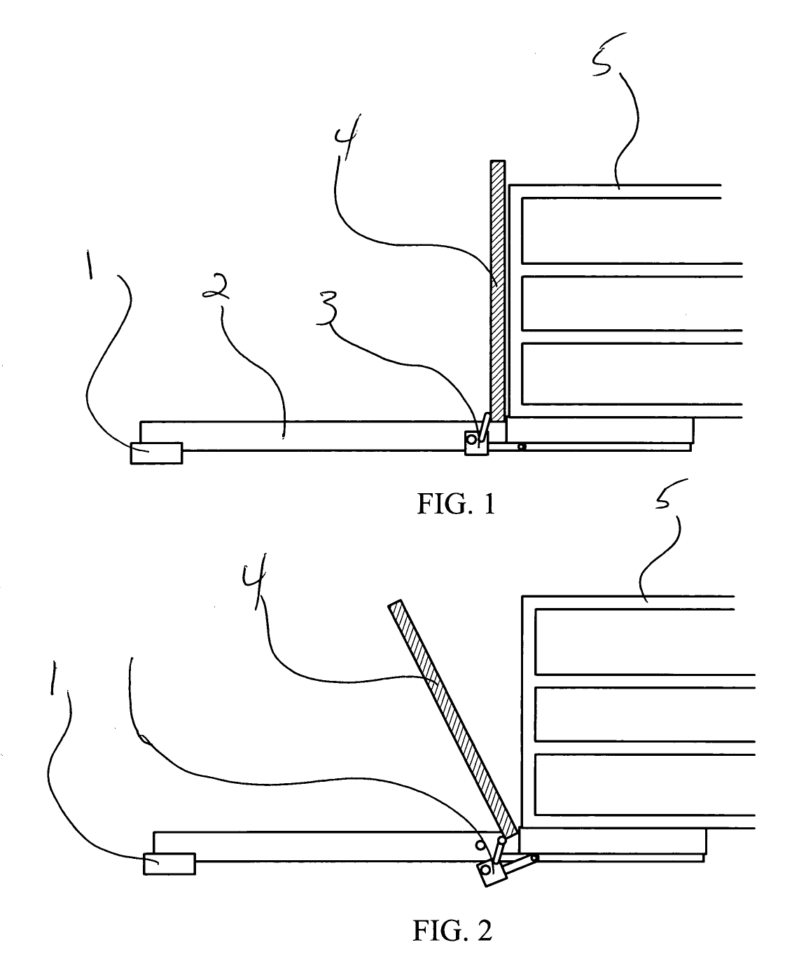

FIG. 2

FIG. 2 is a left side perspective of the current device displaying the device with a trailer hitch connection 1, and trailer neck 2, swivel release 3 in an unlocked position, swivel lock 4 and trailer walls 5.

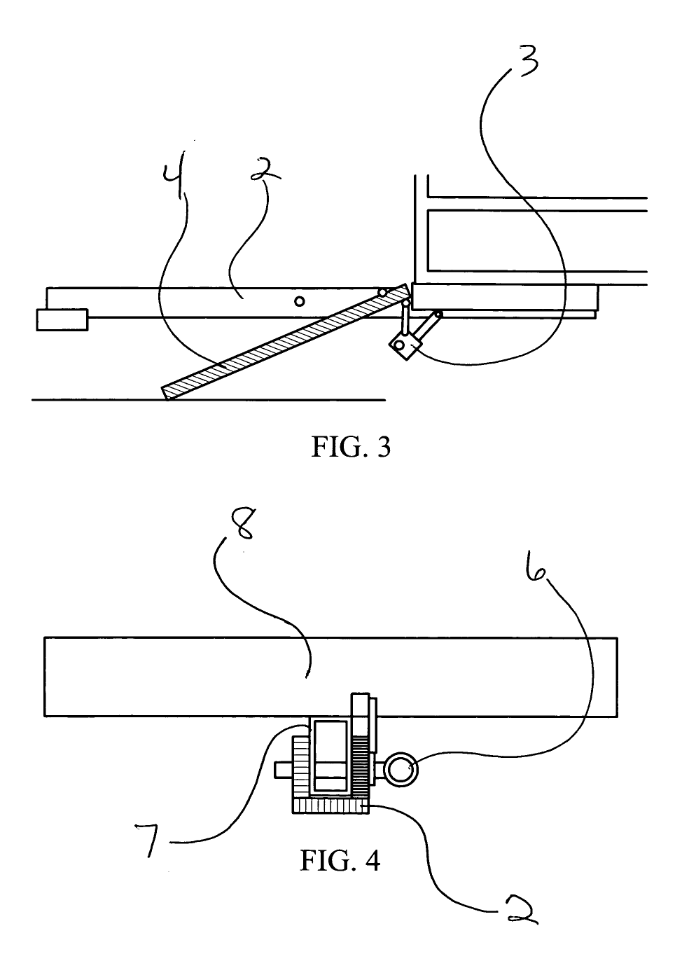

FIG. 3

FIG. 3 is a left side perspective of the current device displaying the device with a trailer swivel lock 4, in a full open position.

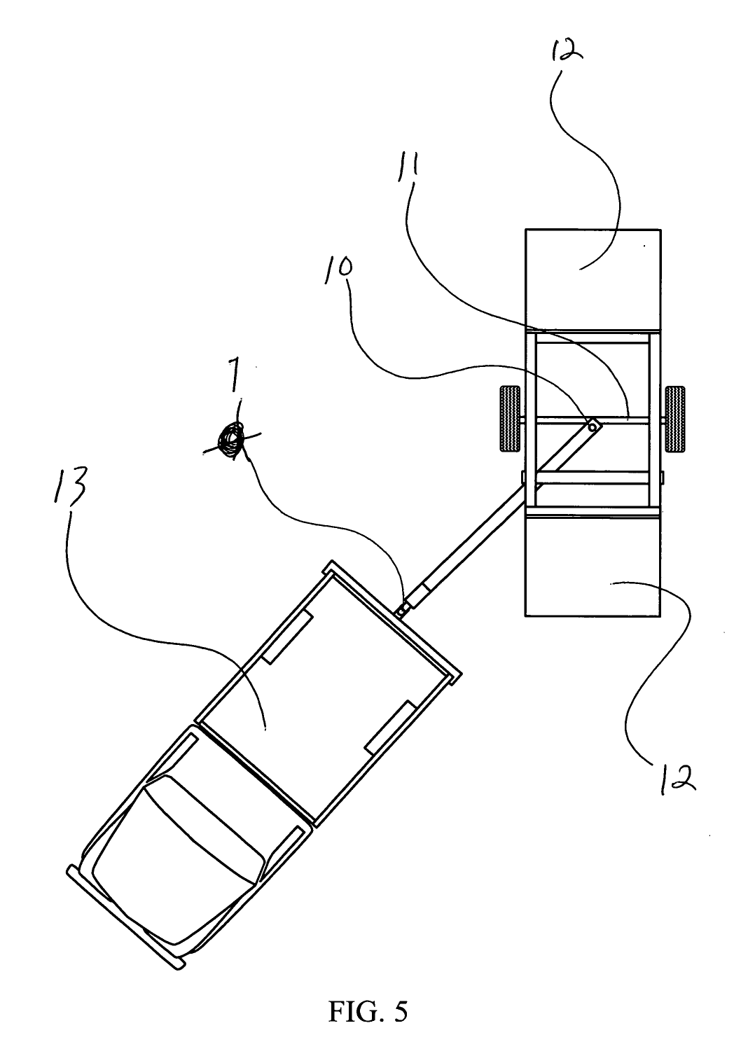

FIG. 4

FIG. 4 is a front, cross section perspective of the trailer neck 2, showing the release pin 6 holding the trailer frame 7, within the trailer neck 2 as located below the trailer device front lower frame 8.

FIG. 5

FIG. 5 is a perspective aerial view of the device hitch connection 1, swivel mount 10, tilt axes 11 cargo ramp 12, and vehicle 13.

### DETAILED DESCRIPTION OF THE ILLUSTRATIONS

As viewed in FIG. 1 the trailer device embodies a hitch connection 1 mounted to the end or front of the trailer neck 2 which attaches to the swivel mount 10 which allows the trailer to rotate on a planar axes for loading cargo from the front or rear cargo ramp 12. The trailer is released for rotational movement by the swivel release 3 and swivel lock 4. Once the swivel lock 4 has been completely released the device can rotate on the swivel mechanism 10 and tilt for loading on the tilt axel 11.

Having thus described the invention, what is desired to be secured by a patent is:

I claim:

1. a trailer device with a swivel mount connecting the trailer frame to the cargo bed allowing the swiveling of the cargo bed for loading or unloading cargo from either the front or rear of the trailer device without detaching from the towing source.

2. A trailer device according to claim 1 wherein;
The trailer bed embodies a swivel mount mechanism manually activated by detaching the cargo bed tongue and moving right or left in a planar motion.

3. A trailer device according to claim 1 wherein;
The trailer device cargo area maintains front and rear loading access.

4. A trailer device according to claim 1 wherein;
The trailer device cargo area embodies a tilt axes to the front or rear allowing the loading edge of the trailer to touch the ground for easy loading and unloading.

5. A trailer device according to claim 1 wherein;
The cargo swivel pin allows the trailer to swivel to either right or left side while still being safely attached to the towing source.

6. A trailer device according to claim 1 wherein;
The cargo bed of the trailer device embodies a loading ramp on both the front and rear of the cargo bed.
